(19) United States
(12) Patent Application Publication
(10) Pub. No.: US 2010/0111401 A1
(43) Pub. Date: May 6, 2010

(54) MASK INSPECTION SYSTEM AND MASK INSPECTION METHOD

(75) Inventors: Yoshiyuki MATSUNO, Shizuoka (JP); Takaki Ito, Aichi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: NuFlare Technology, Inc., Numazu-shi (JP)

(21) Appl. No.: 12/610,770

(22) Filed: Nov. 2, 2009

(30) Foreign Application Priority Data
Nov. 4, 2008 (JP) 2008-283664

(51) Int. Cl. G06K 9/00

(52) U.S. Cl. 382/144

(57) ABSTRACT

A mask inspection system comprises a mask inspection device for detecting defects on a mask according to a plurality of defect detection algorithms for each of which a threshold value is set; and a review device for utilizing an inspection result of the mask inspection device to review defects included in the inspection result while altering the threshold values. The review device includes an inspection result editor for editing a review result that is obtained when one of the threshold values is altered to an optimal value which achieves a desired defect detection level and thus producing an edited inspection result; and an inspection result output unit for outputting the edited inspection result to the mask inspection device. The mask inspection device includes an inspection result management unit for storing the edited inspection result output from the inspection result output unit on a storage unit.

### BACKGROUND OF THE INVENTION

1. Field of the Invention

The present invention relates to a mask inspection system and a mask inspection method.

2. Background Art

Semiconductor device manufacturing involves the use of reticles or photomasks (hereinafter also referred to as masks) for the purpose of forming desired patterns on substrates. The presence of defects on masks affects patterns to be formed; a defect may be transferred onto a pattern. To avoid such undesirable transfer, those masks are conventionally inspected for such defects.

Generally, a mask inspection device allows the operator to select multiple defect detection algorithms based on the attributes of defects. Each of the defect detection algorithms has a threshold value (i.e., a sensitivity parameter), and response values that exceed the threshold values are detected as defects. For this reason, changing the threshold value of a defect detection algorithm results in a change in the number of defects detected (i.e., defect detection rate). As shown in FIG. 4, setting a threshold value at a high sensitivity value results in the detection of not only real defects to be detected but also false defects which need not be detected. As a result, the desired defect detection level cannot be achieved. In order to achieve the desired defect detection level, it is therefore necessary to optimize the threshold values of defect detection algorithms.

A method for optimizing the threshold value of a defect detection algorithm is disclosed, for example, in Japanese Patent Laid-open No. 2004-138563 (Patent Document 1). In the method of Patent Document 1, defect inspection is first performed on a mask by a mask inspection device based on a defect detection algorithm for which a particular threshold value is set, and the inspection result is then reviewed by a review device. If the review result reveals that the desired defect detection level has not been achieved, the threshold, value is altered. Then, defect inspection is performed again by the mask inspection device with the use of the altered threshold value.

During the reinspection, however, the mask inspection device cannot inspect another mask, which lowers the operating rate of the mask inspection device.

A possible solution to the above problem is to detect many defects including false ones by a full inspection in which the threshold value of a defect detection algorithm is set at a high sensitivity value, simulate how the number of the defects changes in response to the alteration of the threshold value, and obtain the optimal threshold value which achieves the desired defect detection level.

Inspection results obtained with the above full inspection include a great number of defects and are thus very large in data volume. Such inspection results are usually stored on the storage unit of a mask inspection device for a certain period of time (e.g., for a year). Thus, such inspection results are likely to cause a capacity shortage in the storage unit of the mask inspection device.

Although inspection results having a smaller amount of data can be obtained by the mask inspection device performing reinspection with the use of the above optimal threshold value, this also lowers the operating rate of the mask inspection device, as stated above.

In view of the above problems, an object of the invention is thus to provide a mask inspection system and a mask inspection method that allow a mask inspection device to store inspection results smaller in data volume without compromising the operating rate of the mask inspection device.

### SUMMARY OF THE INVENTION

According to one aspect of the present invention, a mask inspection system comprises a mask inspection device for detecting defects on a mask according to a plurality of defect detection algorithms for each of which a threshold value is set, and a review device for utilizing an inspection result of the mask inspection device to review defects included in the inspection result while altering the threshold values. The review device includes threshold value altering device for altering the threshold values, editing device for editing a review result that is obtained by the review device when the threshold value altering device alters one of the threshold values to an optimal value which achieves a desired defect detection level, thereby producing an edited inspection result, and output device for outputting the edited inspection result to the mask inspection device. The mask inspection device includes storage device for storing the edited inspection result output from the output device.

According to another aspect of the present invention, in a mask inspection method, a mask inspection device is provided. An inspection result of mask inspection which is performed by the mask inspection device with the use of a plurality of defect detection algorithms for each of which a threshold value is set, is acquired. Defects included in the acquired inspection result are reviewed while altering the threshold values. A review result that is obtained when one of the threshold values is altered to an optimal value which achieves a desired defect detection level is editing, as an edition step, thereby producing an edited inspection result. The edited inspection result is stored in the mask inspection device.

### BRIEF DESCRIPTION OF THE DRAWINGS

FIG. 1 is a block diagram schematically illustrating the configuration of a mask inspection system 1 according to an embodiment of the invention.

FIG. 2 is a diagram showing the data structure of an inspection result.

FIG. 3 is a flowchart illustrating an inspection result storing method.

FIG. 4 is a graph showing the relationship between a threshold value set for a defect detection algorithm and the number of defects detected.

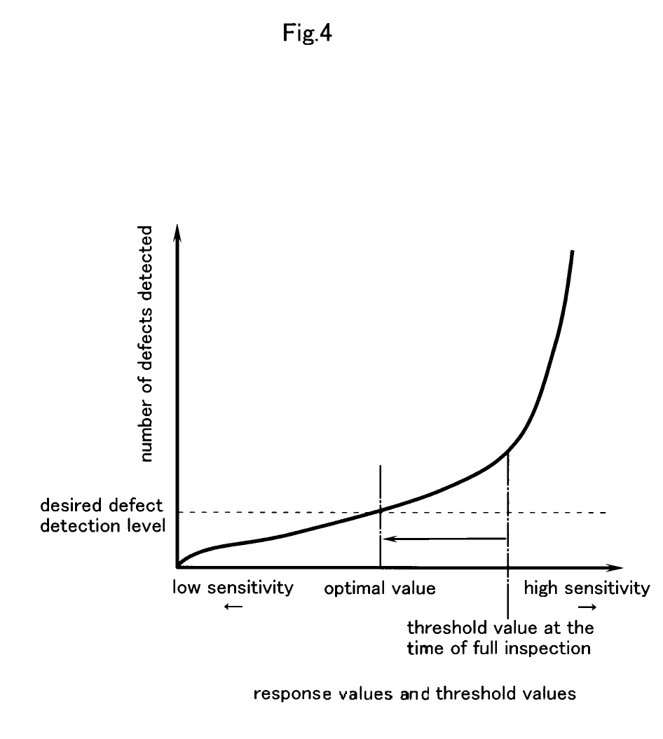

### DETAILED DESCRIPTION OF THE EMBODIMENTS

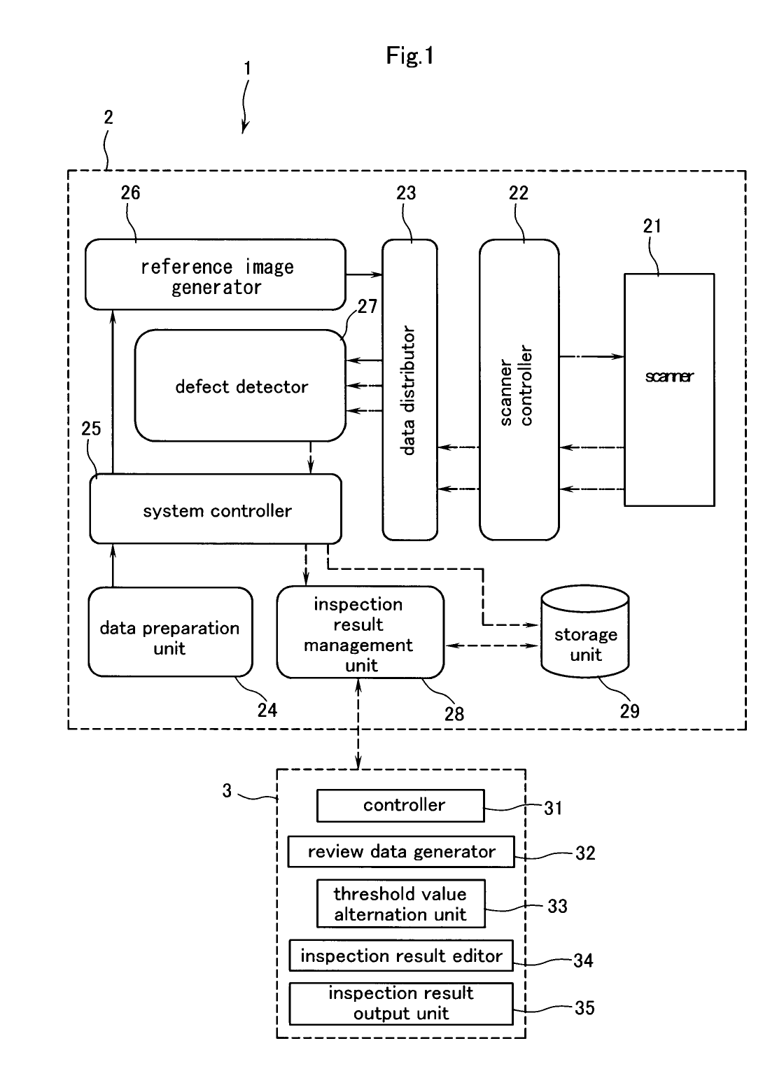

FIG. 1 is a block diagram schematically illustrating the configuration of a mask inspection system 1 according to an embodiment of the invention. FIG. 1 illustrates only the essential components of the invention and is not intended to limit the invention. The defect inspection method of the embodiment is a die-to-database method, but not limited thereto. Instead, it can be a die-to-die method.

The mask inspection system 1 includes a mask inspection device 2 that inspects masks for defects and a review device 3 that performs simulation-based review on the defects by utilizing the inspection result obtained by the mask inspection device 2. The mask inspection device 2 and the review device 3 are connected online.

The mask inspection device 2 is provided with a scanner 21. The scanner 21 scans laser light across a mask, or an inspection object, while moving a stage (not illustrated) on which the mask is placed. The scanner 21 captures images of transmitted and/or reflected light from the mask with the use of an image sensor (e.g., TDI sensor) and thereby obtains optical images of the mask (i.e., transmissive and/or reflective inspection images). The optical images of the mask obtained by the scanner 21 are transferred to a data distributor 23 via a scanner controller 22.

It should be noted that the scanner 21 can also be configured so as to split laser light from a laser light source (not illustrated) with the use of a beam splitter and thereby to obtain transmitted and reflected illumination light at the same time. This allows transmissive and reflective inspections to be performed at the same time.

The scanner controller 22 controls the X-, Y-, and Z-directional movements of the stage of the scanner 21, the tilt angle θ of that stage, and other operations of the scanner 21.

In FIG. 1, the dashed one-dotted arrow represents the flow of a stage control signal for the scanner 21; the dashed two-dotted arrows represent the flows of optical images; the solid arrows represent the flows of design data (CAD data) used for manufacturing masks; and the dashed arrows represent the flows of inspection result data.

A data preparation unit 24 reads out pattern data (CAD data), i.e., mask design data, from a pattern data server not illustrated and transmits the pattern data read out to a system controller 25.

The system controller 25 transfers the received pattern data to a reference image generator 26 so that the reference image generator 26 can generate reference images.

The reference image generator 26 generates reference images by unfolding the received pattern data and transmits the generated reference images to the data distributor 23.

The system controller 25 also allows the operator to select a defect inspection method (transmissive or reflective inspection), or an inspection condition, and a defect detection algorithm based on the attributes of a mask to be inspected and to set any desired threshold value (sensitivity parameter) for the selected defect detection algorithm.

In this case, it is common for the system controller 25 to first set the threshold value at a high sensitivity value for the purpose of detecting many defects including false ones because the review device 3 is capable of changing the threshold value to an optimal value at a later time.

The data distributor 23 transmits, to a defect detector 27, the optical images received from the scanner controller 22 and the reference images received from the reference image generator 26 in a paired manner so that the defect detector 27 can compare the optical images with the reference images.

The defect detector 27 compares the received optical images and reference images. When the comparison result reveals that the response values at unmatched portions between the optical images and reference images are equal to or greater than the threshold value, the defect detector 27 detects those unmatched portions as defects. The defect detector 27 then stores the defects together with their positional coordinate data.

The defect detector 27 can be configured, for example, such that the defect detector 27 inverts the polarity of the electric signals of an optical image and a reference image, adds both of the signals with the use of a logical circuit, and detects portions where the combined signal turns positive or negative as defects.

Further, the defect detector 27 transmits the following data to the system controller 25 as its inspection result: optical images of defects detected; the inspection condition (inspection method); information on the algorithm used to detect the defects; and the response values by which the defects has been detected (i.e., the values that has been found to be equal to or greater than the threshold value upon comparative inspection).

The system controller 25 stores the above inspection result on a storage unit 29. An inspection result management unit 28 reads out the inspection result stored on the storage unit 29 and outputs the inspection result read out to output device (not illustrated) such as a monitor and a printer and also to the review device 3. The inspection result management unit 28 can also store the inspection result on an external storage unit as a backup.

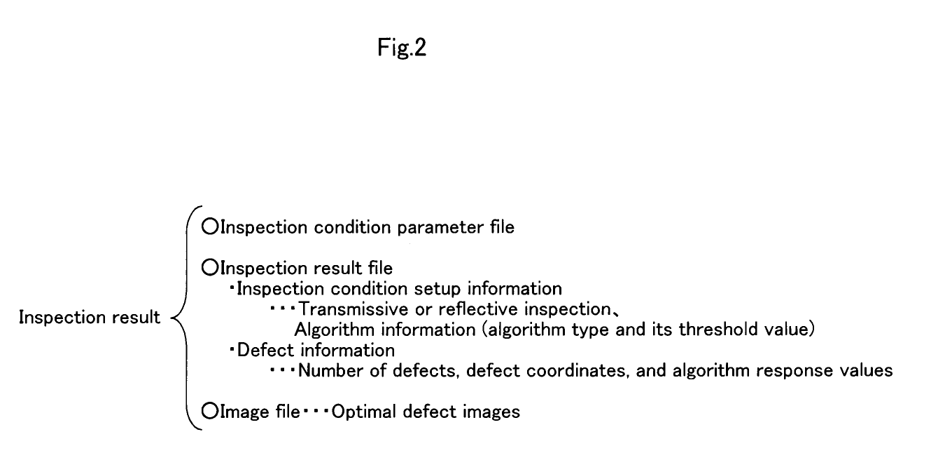

FIG. 2 is a diagram showing the data structure of the inspection result. The inspection result includes an inspection condition parameter file, an inspection result file, and an image file.

The inspection result file stores therein inspection condition setup information and defect information. Examples of the inspection condition setup information include information relating to transmissive or reflective inspection, algorithm information, and the like. Examples of the algorithm information are the type of an algorithm selected, the threshold value set for the algorithm, and the like.

The image file stores therein optical images of defects. The inspection condition parameter file stores therein inspection-related parameters other than the above inspection condition setup information.

As stated earlier, the threshold value for a selected defect detection algorithm needs to be changed to an optimal value for the purpose of achieving the desired defect detection level, i.e., the desired number of defects to be detected. The threshold value can be optimized by detecting known systematic defects on a mask to be inspected.

The optimization of the threshold value can be conducted by the simulation-based review of the review device 3 regardless of whether the mask inspection device 2 is in operation or not. With reference now back to FIG. 1, the configuration and operation of the review device 3 are described below.

The review device 3 includes a controller 31; a review data generator 32 connected to the controller 31; a threshold value alteration unit 33; an inspection result editor 34; and an inspection result output unit 35.

The controller 31 controls the overall operation of the review device 3. The review data generator 32 acquires an inspection result from the inspection result management unit 28 of the mask inspection device 2 and generates review data based on the inspection result acquired. The controller 31 utilizes the review data to display defects on a monitor (not illustrated).

The threshold value alternation unit 33 alters the threshold value of a selected defect detection algorithm in response to input from the operator if defect review with the use of the above review data does not produce the desired defect detection level. If the threshold value is altered by the threshold value alternation unit 33, the review data generator 32 creates review data again based on the altered threshold value.

When the threshold value is altered to an optimal value and the desired defect detection level can be achieved, the inspection result editor 34 then edits the review result into a format similar to that of the inspection result of the mask inspection device 2. More specifically, the inspection result editor 34 deletes information relating to defects which no longer need to be reviewed due to the alteration of the threshold value. The other information necessary for conforming the format of the review result to that of the inspection result, such as the inspection condition parameter file and the like, is duplicated from the inspection result received from the mask inspection device 2.

The above information to be deleted by the inspection result editor 34 includes, for example, defect detection algorithm information which is no longer needed (algorithm type and its threshold value); information on detects which no longer need to be reviewed (defect coordinates and algorithm response values); and optimal image of those defects. Therefore, the inspection result edited by the inspection result editor 34 is smaller in data volume than the inspection result received from the mask inspection device 2.

When a full inspection is performed with the use of, for example, two defect detection algorithms and the operator decides to use only one of the algorisms after optimizing their threshold values during defect review, the inspection result editor 34 alters the threshold value of the one of the algorithms also after the optimization of the threshold values of the two algorithms.

The inspection result output unit 35 outputs the inspection result edited by the inspection result editor 34 (i.e., the review result in a format similar to that of the inspection result received from the mask inspection device 2) to the mask inspection device 2. The inspection result management unit 28 of the mask inspection device 2 receives the edited inspection result from the inspection result output unit 35 and stores it on the storage unit 29.

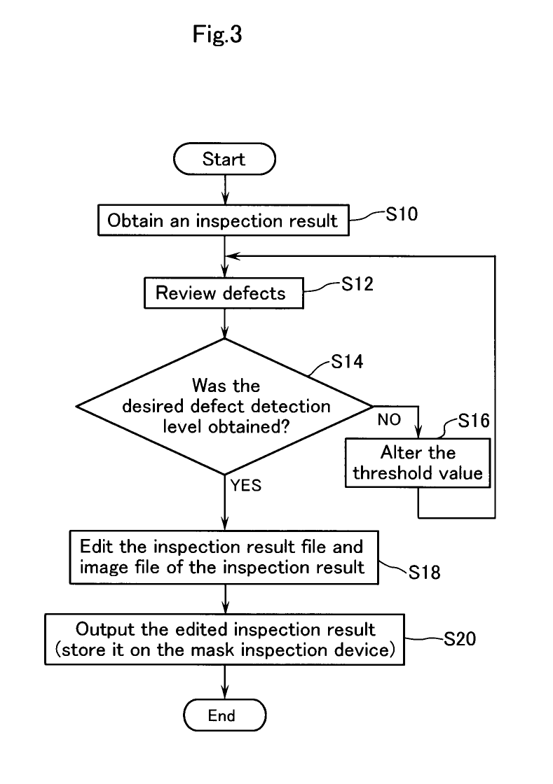

With reference now to FIG. 3, the mask inspection method of the thus-far described embodiment of the invention, more specifically, its inspection result storing method is described. The routine shown in FIG. 3 is invoked by the controller 31 of the review device 3.

The routine starts with the acquisition of an inspection result with the use of a defect detection algorithm for which a particular threshold value is set (Step S10). Acquired in Step S10 is the result of a full inspection that utilizes a defect detection algorithm whose threshold value is set at a high sensitivity value, that is, an inspection result having a huge amount of data (e.g., tens of gigabytes).

In Step S12, defect review is performed based on the acquired inspection result. Then in Step S14, whether or not the desired defect detection level has been achieved is judged. This judgment is made by the operator, and the operator then judges whether the threshold value of the defect detection algorithm is optimal or not. When the judgment operation of Step S14 is performed for the first time, the above threshold value is usually judged to be not optimal.

When the operator judges in Step S14 that the desired defect detection level has not been achieved, the threshold value is altered in response to input from the operator in Step S16. Then, back in Step S12, defect review is performed again with the use of the altered threshold value. Thereafter, the operator judges again in Step S14 whether or not the desired defect detection level has been achieved. By thus altering the threshold value as many times as necessary until the desired defect detection level is achieved, the threshold value can be optimized.

When the operator instead judges in Step S14 that the desired defect detection level has been achieved, the inspection result file and image file of the inspection result acquired in Step S10 are edited in Step S18. More specifically, Step S18 is performed to delete information relating to defects which no longer need to be reviewed due to the alteration of the threshold value. Therefore, the data volume of the inspection result is reduced.

After Step S18, the inspection result edited in Step S18 is output to the mask inspection device 2 and then stored on the storage unit 29 (Step S20).

In the above-described embodiment of the invention, the inspection result editor 34 edits the review result obtained when the threshold value alternation unit 33 of the review device 3 alters the threshold value to the optimal value which achieves the desired defect detection level, thereby producing an edited inspection result of the mask inspection device 2. The edited inspection result is output from the inspection result output unit 35 to the mask inspection device 2 and then stored on the storage unit 29 of the mask inspection device 2. The stored inspection result is lower in data volume than the inspection result obtained by the mask inspection device 2 with the use of a non-optimal threshold value. Therefore, the inspection result reduced in data volume can be stored on the storage unit 29 of the mask inspection device 2 without compromising the operating rate of the mask inspection device 2. Further, because the inspection result obtained with the use of a non-optimal threshold value can be deleted from the storage unit 29, the available capacity of the storage unit 29 can be increased.

It is to be understood that the invention is not limited to the above-described embodiment, but embraces various modifications within the scope thereof. For example, while the respective components 31 to 35 of the review device 3 in the above-described embodiment are computer hardware, the review device 3 can instead be configured by installing computer programs (software) having the functions of those components 31 to 35 on a general-purpose personal computer and by connecting this computer to the mask inspection device 2 in a data-exchangeable manner.

The features and advantages of the present invention may be summarized as follows.

In the first aspect of the invention, the editing device edits a review result that is obtained when the threshold value altering device of the review device alters one of the threshold values to an optimal value which achieves a desired defect detection level, thereby producing an edited inspection result. The edited inspection result is then output to the mask inspection device by the output device and stored in the mask inspection device. Because the inspection result edited by the review device is stored in the mask inspection device, the operating rate of the mask inspection device is not lowered. Further, when the review device performs defect review while altering the threshold values, the data volume of inspection result stored in the mask inspection device tends to be large. However, the mask inspection system of the first aspect of the invention is designed to store in the mask inspection device the inspection result obtained when one of the threshold values of the defect detection algorithms is altered to the optimal value. Therefore, inspection results smaller in data volume can be stored in the mask inspection device.

In the second aspect of the invention, the review result obtained when one of the threshold values is altered to an optimal value which achieves a desired defect detection level is edited to produce an edited inspection result. The edited inspection result is then stored in the mask inspection device. Because the inspection result produced from the review result is stored in the mask inspection device, the operating rate of the mask inspection device is not lowered. Further, when defect review is performed while the threshold values are altered, the data volume of inspection result stored in the mask inspection device tends to be large. However, the mask inspection method of the second aspect of the invention is designed to store in the mask inspection device the inspection result obtained when one of the threshold values of the defect detection algorithms is altered to the optimal value. Therefore, inspection results smaller in data volume can be stored in the mask inspection device.

Obviously many modifications and variations of the present invention are possible in the light of the above teachings. It is therefore to be understood that within the scope of the appended claims the invention may be practiced otherwise than as specifically described.

The entire disclosure of a Japanese Patent Application No. 2008-283664, filed on Nov. 4, 2008 including specification, claims, drawings and summary, on which the Convention priority of the present application is based, are incorporated herein by reference in its entirety.

What is claimed is:

1. A mask inspection system comprising:
a mask inspection device for detecting defects on a mask according to a plurality of defect detection algorithms for each of which a threshold value is set; and
a review device for utilizing an inspection result of the mask inspection device to review defects included in the inspection result while altering the threshold values;
wherein the review device includes:
threshold value altering device for altering the threshold values;
editing device for editing a review result that is obtained by the review device when the threshold value altering device alters one of the threshold values to an optimal value which achieves a desired defect detection level, thereby producing an edited inspection result; and
output device for outputting the edited inspection result to the mask inspection device, and
wherein the mask inspection device includes storage device for storing the edited inspection result output from the output device.

2. The mask inspection system according to claim 1, wherein the editing device deletes, from defect information included in the inspection result of the mask inspection device, information on defects which no longer need to be reviewed due to the alteration of the one of the threshold values to the optimal value.

3. The mask inspection system according to claim 1, wherein the editing device deletes, from defect information included in the inspection result of the mask inspection device, images of defects which no longer need to be reviewed due to the alteration of the one of the threshold values to the optimal value.

4. A mask inspection method comprising:
providing an mask inspection device;
acquiring an inspection result of mask inspection which is performed by the mask inspection device with the use of a plurality of defect detection algorithms for each of which a threshold value is set;
reviewing defects included in the acquired inspection result while altering the threshold values;
editing, as an edition step, a review result that is obtained when one of the threshold values is altered to an optimal value which achieves a desired defect detection level, thereby producing an edited inspection result; and
storing the edited inspection result in the mask inspection device.

5. The mask inspection method according to claim 4, wherein information on defects, the information no longer needing to be reviewed due to the alteration of the one of the threshold values to the optimal value, is deleted from information included in the acquired inspection result.

6. The mask inspection method according to claim 4, wherein images of defects, the images no longer needing to be reviewed due to the alteration of the one of the threshold values to the optimal value, is deleted from information included in the acquired inspection result.

7. The mask inspection method according to claim 4, wherein the edited inspection result stored in the mask inspection device includes inspection condition setup information and defect information.

8. The mask inspection method according to claim 7, wherein the inspection condition setup information includes information relating to transmissive or reflective inspection and information relating to algorithm information.

9. The mask inspection method according to claim 8,wherein the algorithm information includes a type of an algorithm selected and a threshold value set for the algorithm.
